(19) United States
(12) Patent Application Publication
(10) Pub. No.: US 2024/0007190 A1
(43) Pub. Date: Jan. 4, 2024

(54) DYNAMIC GAIN EQUALIZATION CONTROL METHOD FOR USE IN EDFA MODULES

(71) Applicant: Molex, LLC, Lisle, IL (US)

(72) Inventors: Hironori Tachibana, Chiba (JP); Bichang Huang, Shenzhen (CN); Chuang Chao Huang, Zhuhai (CN)

(21) Appl. No.: 18/036,420

(22) PCT Filed: Oct. 18, 2021
(86) PCT No.: PCT/IB2021/059559

§ 371 Date: May 11, 2023

(30) Foreign Application Priority Data
Nov. 12, 2020 (CN) 202011261059.8
Nov. 12, 2020 (WO) PCTIB2021/59599

(51) Int. Cl. H04B 10/294; H01S 3/13; H01S 3/16; H01S 3/067

(52) U.S. Cl. CPC H04B 10/2942; H01S 3/1301; H01S 3/1305; H01S 3/1608; H01S 3/06758; H01S 3/06779

(57) ABSTRACT

A method for gain control for an optical amplifier module is provided. The method may include receiving an input light signal at a first amplifier. The method may include dynamically adjusting a gain of the input light signal based on feedback monitoring of an output light signal. The method may include receiving the gain adjusted light signal at a second amplifier for output of the optical amplifier module.

### RELATED APPLICATIONS

This application claims priority to Chinese Patent Application No. 202011261059.8, filed Nov. 12, 2020, which is incorporated herein by reference in its entirety.

### TECHNICAL FIELD

The present disclosure relates to optical fiber communication systems, and more particularly, but not exclusively, to systems using dynamic gain equalization (DGE).

### BACKGROUND

Optical fiber communication systems have ever greater demands for bandwidth and capabilities. These optical fiber communication systems may include long spans of transmission fiber and use of optical amplifiers including erbium-doped fiber amplifiers (EDFA). The large number of amplifiers used in long haul communication systems are used to compensate for signal loss in the spans of optical fiber. The multiplicity of EDFA introduces distortions and irregularities in the transmission signal. In some instances, the generated gain curves combine to create an uneven gain profile, or gain ripple. Gain ripple may negatively affect signal transmission and processing.

Accordingly, there is a need for improved capabilities to address the gain ripple in optical fiber communication systems.

In addressing the undesirable gain ripple, there is also an opportunity to improve signal quality through improved amplifier noise or noise figure.

### SUMMARY

In an aspect of the disclosure, a method for gain control for an optical amplifier module is provided. The method may include receiving an input light signal at a first amplifier. The method may include dynamically adjusting a gain of the input light signal based on feedback monitoring of an output light signal. The method may include receiving the gain adjusted light signal at a second amplifier for output of the optical amplifier module.

In another aspect of the disclosure, an optical amplifier module is provided. The optical amplifier module may include a first stage comprising a first amplifier for receiving a light signal. The optical amplifier module may include a second stage comprising a second amplifier for outputting a boosted light signal. The optical amplifier module may include a gain control module coupled to the first stage and the second stage, the gain control module for receiving the light signal from the first stage for output to the second stage, and further configured to dynamically adjust a gain based on feedback monitoring of the output boosted light signal.

### BRIEF DESCRIPTION OF THE DRAWINGS

FIG. 1 is a diagram illustrating a variable gain EDFA module.

FIG. 2 is a diagram illustrating a variable gain EDFA module including DGE control.

FIG. 3A is a diagram illustrating another exemplary EDFA module including DGE control.

FIGS. 3B-3C are charts representing the input signal and output signal of the exemplary EDFA module of FIG. 3A.

FIG. 4 shows gain variation of an EDFA including a variable optical attenuator (VOA) attenuation plotted by gain variation against the wavelength.

FIG. 5 is a chart illustrating example output signal spectrum at different attenuation levels.

FIG. 6A shows the noise figure in decibel (dB) over a given gain range of, for example, embodiments using an VOA and a DGE.

FIG. 6B is based on the same set up as FIG. 6A plotting average loss over the given gain range.

FIG. 7 shows an example EDFA gain shape may be derived from input power spectrum and output power spectrum.

FIG. 8 shows the DGE attenuation shape and real EDFA gain shape alongside the target EDFA gain shape.

FIG. 9 is a block diagram illustrating an example method for DGE control.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. It will, however, be apparent to those skilled in the art that these concepts may be practiced without these specific details. In some instances, well known structures and components are shown in block diagram form in order to avoid obscuring such concepts.

Several aspects of the DGE control modules will now be presented with reference to various apparatuses and methods. These apparatuses and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), application-specific integrated circuits (ASIC), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), solid-state devices (e.g., solid-state drives or solid-state disks (SSD), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials.

The exemplary methods and apparatuses discussed infra are applicable to any of a variety of control modules such as the DGE modules but may be more generally applicable to gain, ripple, and noise control for optical amplifiers. To simplify the discussion, the exemplary methods and apparatuses are discussed within the context of these example embodiments. One of ordinary skill in the art, however, would understand that the exemplary methods and apparatuses are applicable more generally to a variety of optical fiber signal control mechanisms. Disclosed herein are systems and methods for improved DGE control of the optical amplifiers, and in particular EDFA, and the signaling within the communication systems.

Operation of optical fiber systems require amplifiers due to long spans and signal quality. In some instances, the power through the amplifiers causes undesirable power ripples through the system. The power ripples or gain ripple may be associated with the combination of gain curves from multiple amplifiers each having a different gain curve. The cumulative gain curve (or gain ripple) may have an uneven gain profile. The embodiments in this disclosure address some of these undesirable qualities and may at the same time provide improved optical signal-to-noise ratio (OSNR).

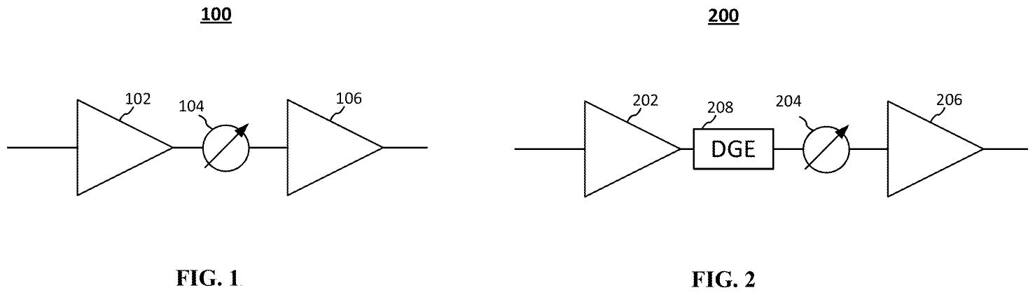

FIG. 1 illustrates an example embodiment of a variable gain EDFA module 100. The amplifier module 100 may include a pre-amplifier stage 102 for amplifying the input optical signal, a variable optical attenuator (VOA) 104, and an amplifier 106 at the output that may be called a booster stage amplifier. In some instances, a gain flattening filter (GFF) may reside in amplifier 106. The gain flattening filter (GFF), also known as an equalizing filter, may normalize or smooth out the gain over a range of frequencies of the input signal. In such instances, one or more channels may have the same or substantially similar gain.

In some embodiments, the GFF may reside at amplifier 102 or amplifier 106. The VOA 104 may be used to flatten the gain. The relationship between the EDFA module gain and the VOA attenuation is shown below in the formula:

EDFA_{gain}=OFG_{gain}−VOA_{IL} (Equation 1)

OFG_{gain} means the maximum optical flattening gain with minimum VOA insertion loss (IL). The loss shape of GFF is designed to make the gain flat at this condition. That is, when the EDFA module operates at OFG_{gain}, the VOA may be close to 0 dB. When the EDFA operates at a gain lower than the OFG, the equation is as follows:

VOA_{IL}=OFG_{gain}−EDFA_{gain} (Equation 2)

The value of EDFA_{gain} decrease is equal to the value of VOA_{IL} increase, so the gain of EDFA (gain of pre-amp and booster) may have no change, is maintained in the OFG.

This method may maintain a flattening gain spectrum, but as the VOA attenuation is very large in the low gain range, the noise figure (NF) may have correspondingly significant degradation.

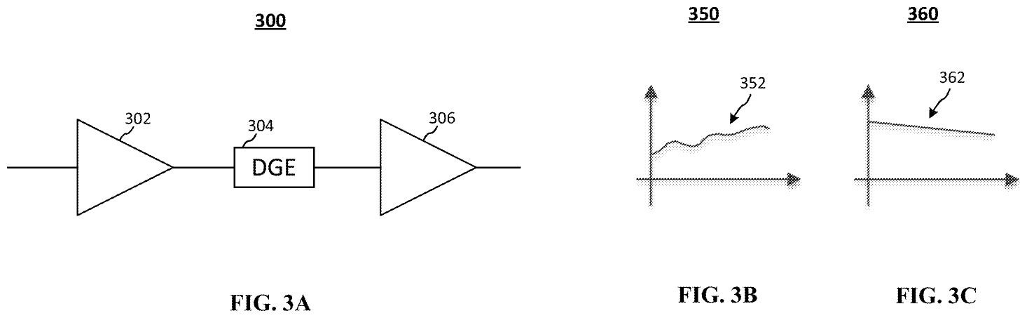

FIG. 2 illustrates an embodiment of an EDFA module 200 including DGE control. Another way for addressing gain control may be through DGE 208 for dynamic gain ripple tuning. In one method, the DGE 208 may be only used to eliminate the gain ripple. The DGE 208 may be located in the middle stage and work with the VOA 204. The DGE 208 may be variable on loss shape, but when the shape changes, the gain on the EDFA 200 may change also which makes the gain shape change accordingly (appearing as a tilt in the gain), so that the VOA 204 may be used to compensate the DGE loss to keep the gain (OFG). In an example, the designed middle state loss (DMSL) may be 8 dB, if the average DGE attenuation is 7 dB, then the VOA 204 may pad the loss with 1 dB, if the average DGE attenuation is 1 dB, then the VOA 204 may pad the loss with 7 dB.

In some embodiments, the DGE 208 may be coupled to a processor module (not shown), or the DGE 208 may incorporate a processor module. The processing module may include hardware and/or software, firmware, etc.

The average insertion loss is given by the equation below:

$${IL}_{DGE - AVG} = \frac{{\sum }_{i = 1}^{n} ρ ( i ) * {IL}_{DGE} ( i )}{{\sum }_{i = 1}^{n} ρ ( i )} \qquad ( Equation 3 )$$

The insertion loss of the VOA 204 may be given by the equation below:

IL_{VOA}=DMSL−IL_{DGE-AVG} (Equation 4)

ρ(i) is the power of channel i. From Equation 3 and Equation 4, we know that the sum loss of the VOA 204 and DGE 208 may be fixed. This control method may flatten the gain spectrum, but as VOA needs to pad the losses, especially when the DGE loss padding is far less than DMSL, so the noise figure may degrade substantially too.

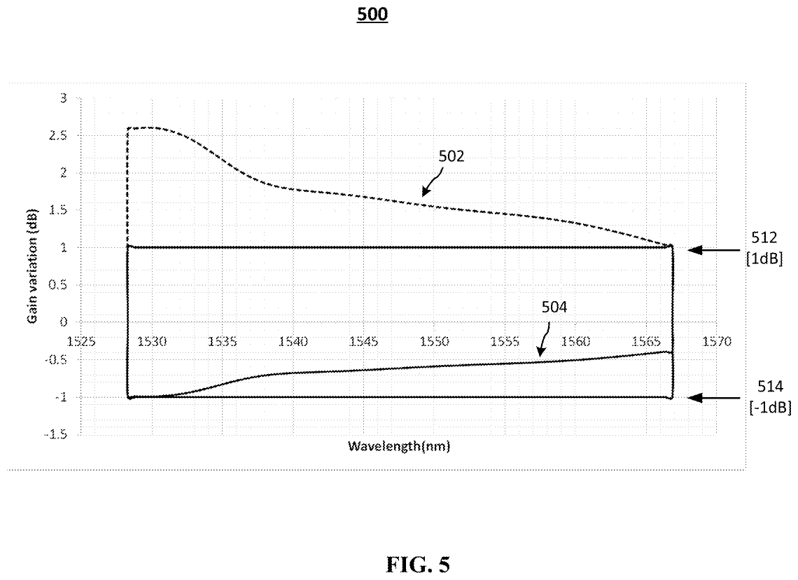

FIG. 4 shows gain variation of an EDFA including VOA attenuation plotted by gain variation (Y axis) against the wavelength (X axis). The chart 400 shows a curve 402 with an EDFA gain rise of 2 dB, a curve 404 with an EDFA gain rise of 1 dB, a curve 406 with a reference gain, a curve 408 with a gain drop of 1 dB, and a curve 410 with a gain drop of 2 dB. As shown in the chart 400, the gain curves of the EDFA exhibit undesirable characteristics including gain tilt showing larger variation at one end of the wavelength axis.

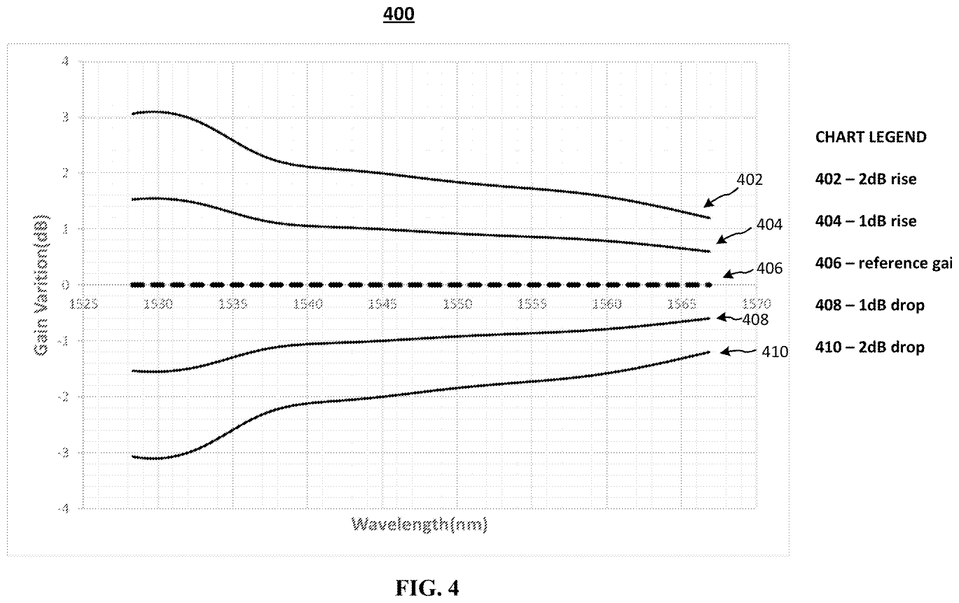

FIG. 3A illustrates another exemplary EDFA module 300 including DGE control. The block diagram example of FIG. 3A shows a control method that may be composed of a pre-amp stage 302, post amp stage 306, and DGE 304. In the example illustrated, the signal may pass directly between the pre-amp and post-amp via the DGE 304 without other components such as the VOA. The VOA, however, may be an optimal element that may be included in some embodiments, either before or after the DGE 304.

In the previous embodiments, the gain ripple may be removed to make the output spectrum flat or smooth. But the previous embodiment needs some VOA attenuation which may degrade the noise figure, especially at low gain ranges or the DGE padded loss is far less than the DMSL. The embodiments (e.g., of FIG. 3A) may tune the spectrum and at the same time decrease the loss as much as possible. As the loss decreases, the optical signal-to-noise ratio (OSNR) will improve over other embodiments.

In the following embodiments, the gain of the EDFA may not necessarily be fixed at the OFG. The change of EDFA gain may cause variation of the gain across the spectrum. What's more, the variation over the wavelengths may be linear. FIG. 4 shows the EDF gain variation from −2 dB to 2 dB. EDFA gain shape may be calculated from the OFG gain. There may be EDFA gain variation based on the OFG and DGE attenuation shape. The equation may be given by:

Gain_{EDFA}(i)=Gain_{OFG}(i)+Gain_{EDF-R}(i)*k−IL_{DGE}(i) (Equation 5)

Gain_{EDF-R} (i) is the EDFA gain profile variation ratio (FIG. 4, curve 404 for 1 dB rise).

k is the coefficient which has a relationship to the gain difference from OFG. (At 3 dB gain change case, k is 3 times to that of 1 dB gain change case.)

Gain_{OFG}(i) is the optimized flattening gain in design. Generally, it may need less DGE manipulation. It may be the same value regardless of the channel i (in other words, different channels may have the same value).

Gain_{EDFA}(i) is the EDFA target required gain shape. It may be tilted or any desired shape. The shape may be defined by a function or may be manually constructed. Any shape or curve may be used as dictated by design or preference.

IL_{DGE}(i) is the DGE attenuation shape. For any channel i, IL_{DGE}(i) may be larger or equal to 0. In order to get small noise figure, it may be desired that the minimum of IL_{DGE}(i) is as close to zero as much as possible.

FIGS. 3B-C are example charts illustrating the input signal and output signal of the exemplary EDFA module 300 of FIG. 3A. In chart 350 of FIG. 3B, the input signal 352 may include power ripples due to uneven gain curves from the amplifiers of preceding spans. In chart 360 of FIG. 3C, the output signal 362 may include a flattened curved based on the DGE control.

Another method for control may be described as follows. The DGE attenuation shape may be achieved by:

IL_{DGE}(i)=Gain_{OFG}(i)+Gain_{EDF-R}(i)*k−Gain_{EDFA}(i) (Equation 6)

In Equation 6, the k may be achieved by:

$$\begin{matrix}A ( i ) = \frac{{Gain}_{EDFA ( i )} - Gain\_IFG ( i )}{Gain\_EDF \_R ( i )} & ( Equation 7 ) \\ K = max ( A ( i ) ) & ( Equation 8 )\end{matrix}$$

Equation 8 may be one possible optimization function. One option for optimizing or maximizing the function is to find the local or global maximum of Equation 6. In some embodiments, k may be adjusted in steps or continuously to determine the maximum function. It will be appreciated by those skilled in the art that optimization or maximizing may be achieved in any number of ways through any number of functions and steps. Equation 7 is merely one exemplary method for optimization.

In one embodiment, it may be desirable to achieve flat and variable gain. The gain of this type for EDFA may be tunable, but the gain shape may be flat so that the gain value for all the channels is the same.

Based on Equations 6-8, we know that when EDFA gain is equal to OFG gain, then k=0, the DGE attenuation of all channels is close to zero dB. When the EDFA gain is higher than the OFG gain, k will keep increasing until minimal gain (longest wavelength) reaches the target gain. DGE attenuates the part above the target.

When EDGA operates at the gain lower than the OFG, k will decrease until minimal gain (shortest wavelength) reaches the target gain, DGE attenuation attenuates the part above the target gain.

In one example, in the C-band EDFA, assuming the gain is a certain dB above the OFG, k will be 1.68*x and average DGE loss will be about 0.7*x dB. Assuming the gain is x′ dB under ODG, then k will be −0.6*x′ and average DGE loss will be about 0.35*x′ dB. In other words, the noise figure may be improved because the DGE loss decreases from x to 0.35x.

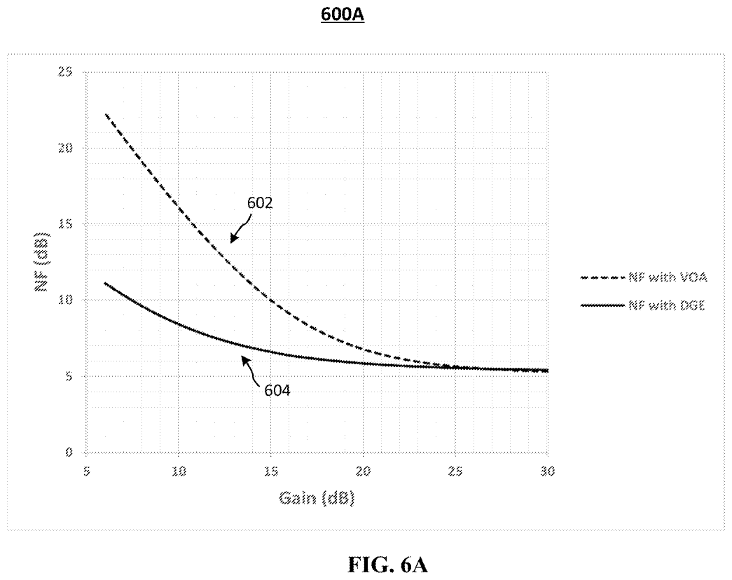

In FIG. 5, the chart 500 shows the EDF gain shapes and EDFA gain shapes or curves 502, 504 with DGE attenuation shape when using C-Band EDFA gain rise or drop of 1 dB. In embodiments without the technique such as the one in FIG. 3A, the average loss variation may be 1 dB per dB gain drop from the OFG. The signal loss in the embodiments such as FIG. 3A may be less, and in some instances, the reduction in signal loss may be approximately a third of previous embodiments. The improved embodiments may improve the noise figure greatly. As the DGE may compensate the gain shape variation above the OFG, so it may shift the OFG several dB lower than the previous embodiments. In this way, the embodiments may improve the noise figure at a low gain range even further.

As illustrated in FIG. 5, the curves 502, 504 of the gain responses in dB (Y axis) vary over the given wavelength range (X axis). When there is a 1 dB rise (marker 512 shows the level 1 dB rise), the curve 502 has a larger variance from 1 dB at lower wavelengths. As the wavelength gets larger, the gain variation diminishes, and eventually reaches 1 dB. For a 1 dB drop (marker 514), the curve 504 has a larger variance at higher wavelengths with the gain variation from −1 dB and eventually reaching zero at lower wavelengths.

In the 1 dB gain curve 502, the variation may be compensated by the DGE to improve the noise figure. In some instances, the curves 502, 504 may be known during design or development of the devices, with the curves determined based on a formula or a given gain shape. In other instances, the curves 502, 504 may not be known until deployment due to environmental or installation differences. In such instances, the curves may be determined by any combination of factors including monitored responses, formulas, predetermined shapes, etc. The curves and compensation of the gain for these curves may be provided accordingly. In the example of FIG. 5, the curves 502, 504 may be used to compensate for the variation in gain to bring the gain response to 1 dB for curve 502 (or −1 dB for curve 504).

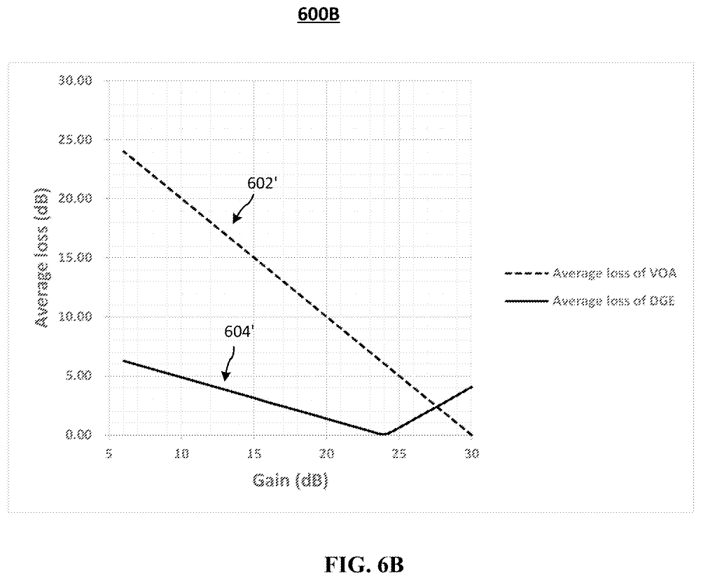

FIG. 6A shows a chart 600A with the noise figure in dB (Y axis) over a given gain range (X axis) for example embodiments using an VOA and a DGE. Chart 600A shows testing using an example EDFA with a gain range of 6 dB to 30 dB, wavelength with range of approximately 1527.38 nm to 1566.72 nm.

Curve 602 shows the results of the embodiment using a VOA based on using Equation 2 to calculate the VOA attenuation. Curve 602 shows significant noise at low gains. Curve 604 shows the results of the embodiment using a DGE based on using Equations 6-8 to calculate the DGE attenuation shape. As shown in this chart 600, using DGE provides improved noise figure over most of the gain range with significant improvements at low gain.

FIG. 6B is based on the same set up as FIG. 6A plotting average loss over the given gain range. The average loss is the average value of the loss in different wavelength channels.

Curve 602′ shows the results of the embodiment using a VOA based on using Equation 2 to calculate the VOA attenuation. The OFG is at 30 dB. Curve 602′ shows large average losses at low gains. Curve 604′ shows the results of the embodiment using a DGE based on using Equations 6-8 to calculate the DGE attenuation shape. The OFG moves to 24 dB. As shown in this chart 600B, using DGE provides improved average losses over most of the gain range with significant improvements at low gain.

We know after changing to the new embodiment, the noise figure improves dramatically at low gain range and almost no difference at high gain. The average loss of the inventive method is largely lower than traditional methods at low gain ranges. It may be appreciated that the new method may decrease the middle stage loss and improve noise figure.

In another embodiment, the required shape of the EDFA gain may not always be flat. In this embodiment, the shape of the gain may be configurable. In some circumstances, there may be a big incremental gain ripple or Raman effect introduced gain tilt on the input power, but output power needs to remain flat. In this case, the gain shape may need to be tuned by the DGE.

In Equation 6, the EDFA gain may be a vector which is calculated from input power spectrum and target output spectrum.

Gain_{EDFA}(i)=Power_{EDFA-OUT}(i)+Power_{EDF-IN}(i) (Equation 9)

In this Equation 9, Power_{EDF-IN}(i) is the EDFA input power spectrum. Power_{EDFA-OUT}(i) in the EDFA may be the target power spectrum. They may be any spectrum as desired or for system design.

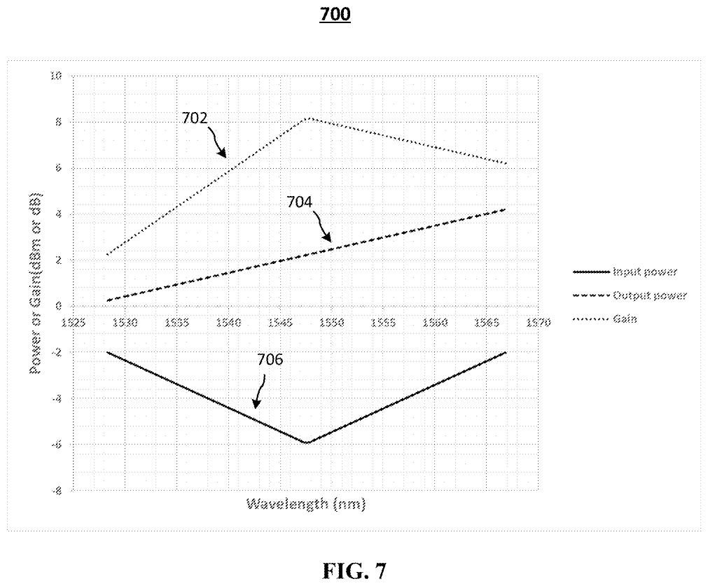

FIG. 7 shows an example EDFA gain shape may be derived from input power spectrum and output power spectrum. The input power spectrum 706 may be a triangular curve 706, the desired output power spectrum may be a positive slope 704. Based on the input power spectrum and desired output power spectrum, the gain shape 702 may be determined. The input power may be known from, for example, the users of the device (e.g., customers of the communication systems operators or providers). The output power may be known from, for example, the users of the device (e.g., the communication systems operators or providers). The gain shape 702 in the example of FIG. 7 may be a sloped triangular curve 702. In general, any shapes of the input power, gain, and output power may be used.

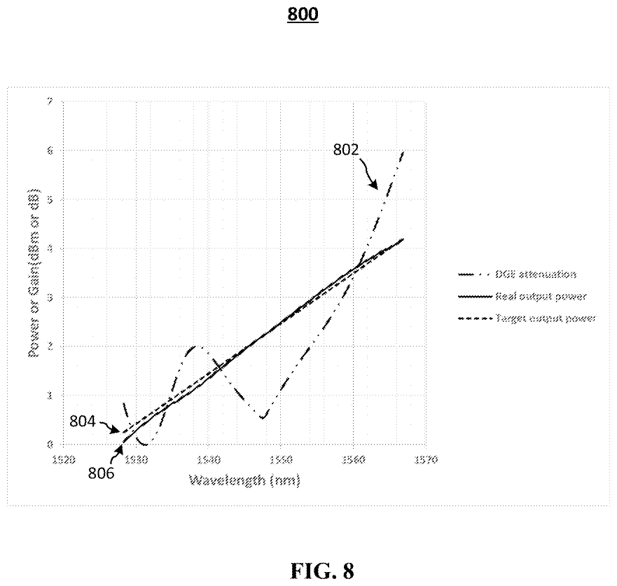

FIG. 8 shows the DGE attenuation shape 802 (dash-dot line) and real EDFA gain shape 806 (solid line) alongside the target EDFA gain shape 804 (dash line). The error between the target output power 804 and real output power 806 may be small.

The inventive control method may be to find the minimum DGE loss setting even in this case, which may be to minimize the average loss of mid-stage and improve the noise figure in the same manner as described for the various embodiments.

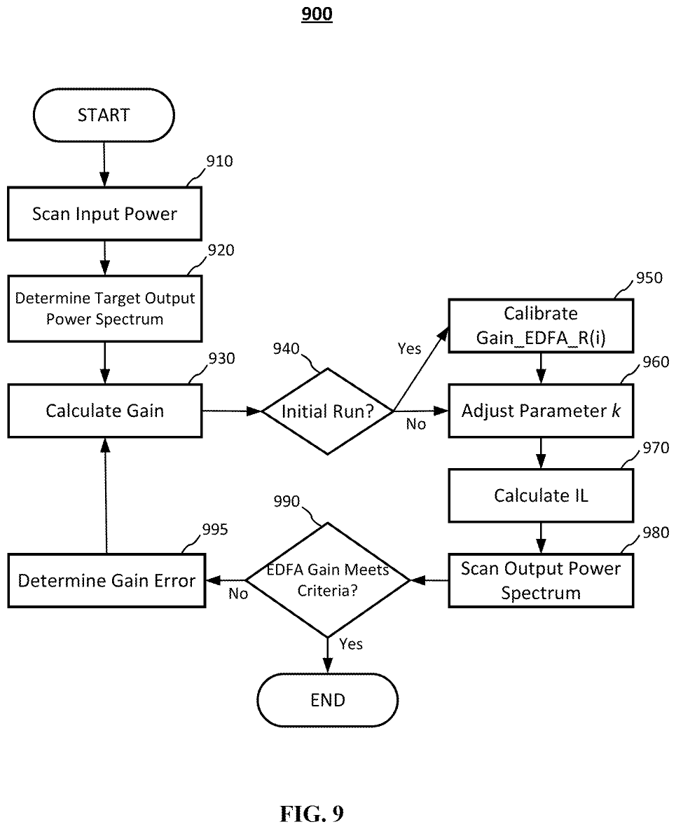

FIG. 9 is a block diagram illustrating an example method for DGE control. The method 900 may be performed by the DGE embodiments of FIG. 3A. At step 910, the method may include scanning the input power. For example, the module may determine the input power of the amplifier module. At step 920, the method may include determining a target output power spectrum. The target output spectrum may be predetermined, e.g., during manufacture or may be programmed by a user. In other embodiments, the target output spectrum may be determined at run time. At step 930, the method may include calculating the desired gain. At step 940, the method may include determining if the method is performing the initial run (first run). If the method is performing the initial run (“yes” path), the method may proceed to 950. At step 950, the method may calibrate the Gain. Returning to step 940, if the method is performing a second or later run (“no” path), then the method may proceed to step 960. It will be appreciated that these steps are merely exemplary, and other orders and arrangements are possible.

At step 960, the method may adjust the parameter k. At step 970, the method may calculate the insertion loss, e.g., based on the current signal. At step 980, the method may scan the power spectrum. At step 990, the method may determine whether the EDFA gain meets some criteria. For example, the criteria may be conformity to the gain shape or other criteria based on design or user preference. If the EDFA gain meets the criteria, the method may end. If the EDFA gain does not meet the criteria, then the method may proceed to step 995. At step 995, the method may determine the gain error and proceed to step 930.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for gain control for an optical amplifier module, the method comprising:
receiving an input light signal at a first amplifier;
dynamically adjusting a gain of the input light signal based on feedback monitoring of an output light signal;
receiving the gain adjusted light signal at a second amplifier for output of the optical amplifier module.

2. The method of claim 1, further comprising scanning an input power spectrum of the input light signal for dynamic adjusting the gain at a control module.

3. The method of claim 1, further comprising determining a target output power spectrum, wherein dynamically adjusting the gain is based on meeting a threshold error of the target output power spectrum.

4. The method of claim 3, wherein the output power spectrum is based on a level gain output.

5. The method of claim 3, wherein the output power spectrum is based on a predetermined gain shape.

6. The method of claim 1, further comprising calculating a gain for dynamically adjusting the gain, the calculated gain determining an end goal gain for the feedback monitoring.

7. The method of claim 2, further comprising:
calculating a gain constant for adjusting the gain control; and
applying the calculated constant at the gain control module.

8. The method of claim 7, further comprising:
scanning an output power spectrum of the light signal at the output of the second amplifier stage; and
comparing the output power spectrum to the target output power spectrum;
maintaining the gain constant at a same value in response to determining the scanned output power spectrum is within a threshold margin of the target output power spectrum;
iterating to dynamically adjusting the gain in response to determining the scanned output power spectrum is not within a threshold margin of the target output power spectrum.

9. The method of claim 1, wherein dynamically adjusting the gain is based on one of a recursive or loop control function.

10. The method of claim 9, further comprising adjusting based on an optimization function using the loop control function.

11. The method of claim 10, wherein the optimization function is based on a localized maximization function for determining an optimal power spectrum output of the light signal.

12. The method of claim 1, further comprising passing the gain adjusted output directly to the output amplifier.

13. The method of claim 1, wherein the amplifiers are erbium-doped fiber amplifiers.

14. The method of claim 1, wherein at least one of the first amplifier or second amplifier is a gain flattening amplifier.

15. An optical amplifier module comprising:
a first stage comprising a first amplifier for receiving a light signal;
a second stage comprising a second amplifier for outputting a boosted light signal;
a gain control module coupled to the first stage and the second stage, the gain control module for receiving the light signal from the first stage for output to the second stage, and further configured to dynamically adjust a gain based on feedback monitoring of the output boosted light signal.

16. The optical amplifier module of claim 15, wherein the gain control module configured to dynamically adjust the gain comprises adjusting based on an optimization function.

17. The optical amplifier module of claim 16, wherein the gain control module comprises memory storing at least one level gain value or predetermined gain shapes, and the optimization function is based on optimizing for the level gain value or predetermined gain shapes.

18. The optical amplifier module of claim 15, wherein the first amplifier or second amplifier or both are erbium-doped fiber amplifiers.

19. The optical amplifier module of claim 15, wherein at least one of the first stage or second stage is a gain flattening amplifier.
